(19) United States
(12) Patent Application Publication
(10) Pub. No.: US 2024/0154958 A1
(43) Pub. Date: May 9, 2024

(54) ELECTRONIC INFORMATION PROCESSING SYSTEM, ELECTRONIC INFORMATION PROCESSING METHOD, AND PROGRAM

(71) Applicant: SEIKO EPSON CORPORATION, Tokyo (JP)

(72) Inventor: Ryo HIRAYAMA, SHIOJIRI-SHI (JP)

(21) Appl. No.: 18/502,363

(22) Filed: Nov. 6, 2023

(30) Foreign Application Priority Data
Nov. 7, 2022 (JP) 2022-178141

(51) Int. Cl. H04L 9/40; G06K 7/14

(52) U.S. Cl. CPC H04L 63/0853; G06K 7/1417

(57) ABSTRACT

An electronic information processing system includes a first information processing device and a second information processing device configured to store electronic information. The first information processing device displays a code in which a URL of a web page is recorded. The second information processing device reads the code displayed by the first information processing device, accesses the URL acquired from the read code to display the web page, and transmits image data to a server device via the displayed web page. The first information processing device receives the image data from the server device.

The present application is based on, and claims priority from JP Application Serial Number 2022-178141, filed Nov. 7, 2022, the disclosure of which is hereby incorporated by reference herein in its entirety.

### BACKGROUND

### 1. Technical Field

The present disclosure relates to an electronic information processing system, an electronic information processing method, and a program.

### 2. Related Art

In related art, a technique is known in which an information processing device transmits electronic information to another information processing device. For example,

JP-A-2008-305334 discloses an image printing system in which a mobile phone terminal transmits image data of an image taken by a digital camera of the mobile phone terminal to a store server or a lab server.

However, in the system disclosed in JP-A-2008-305334, it is necessary to install a dedicated application, register an email address, or the like in order to transmit the image data to the store server or the lab server, and a procedure for transmitting the image data is complicated.

### SUMMARY

An electronic information processing system according to the present disclosure includes: a first information processing device; and a second information processing device configured to store electronic information. The first information processing device is configured to display a code in which a URL of a web page is recorded. The second information processing device is configured to read the code displayed by the first information processing device, access the URL acquired from the read code to display the web page, and transmit the electronic information to a server device via the displayed web page. The first information processing device is configured to receive the electronic information from the server device.

An electronic information processing method according to the present disclosure includes: a first information processing device displaying a code in which a URL of a web page is recorded; a second information processing device configured to store electronic information reading the code displayed by the first information processing device, accessing the URL obtained by reading the code to display the web page, and transmitting the electronic information to a server device via the displayed web page; and the first information processing device receiving the electronic information from the server device.

A program according to the present disclosure causes a processor of an information processing device to function as a display control unit configured to display a code in which a URL of a web page is recorded, and a receiving unit configured to receive, from a server device, electronic information stored in another information processing device different from the information processing device after the code is read, the electronic information being transmitted to the server device via the web page displayed by the other information processing device.

### BRIEF DESCRIPTION OF THE DRAWINGS

FIG. 1 is a diagram showing a configuration of a printing system.

FIG. 2 is a diagram showing a configuration of a user terminal, a store terminal, and a server device.

FIG. 3 is a diagram showing an example of a web page.

FIG. 4 is a diagram showing an example of a first store screen.

FIG. 5 is a diagram showing an example of a second store screen.

FIG. 6 is a sequence diagram showing an operation of the printing system.

FIG. 7 is a sequence diagram showing an operation of the printing system.

FIG. 8 is a sequence diagram showing an operation of the printing system.

FIG. 9 is a sequence diagram showing an operation of the printing system.

### DESCRIPTION OF EMBODIMENTS

1. Configuration of Printing System

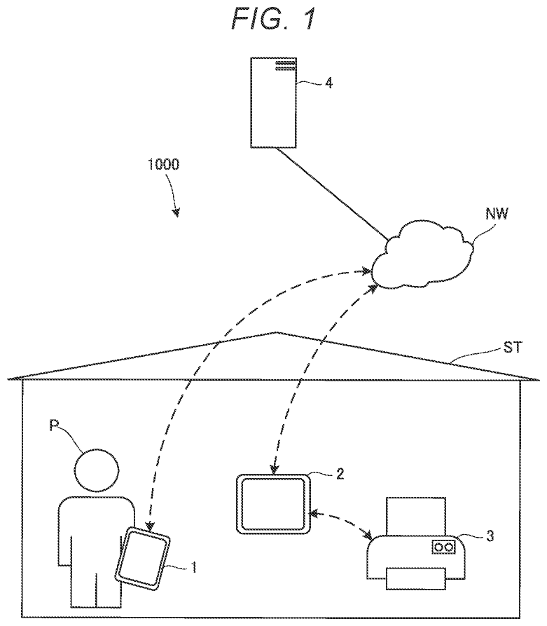

FIG. 1 is a diagram showing a configuration of a printing system 1000.

The printing system 1000 is a system in which a customer terminal 1 transmits image data to a store terminal 2 and the store terminal 2 processes the image data received from the customer terminal 1. The customer terminal 1 is a terminal device used by a customer P. The store terminal 2 is a terminal device installed in a store ST.

The printing system 1000 corresponds to an “electronic information processing system” according to the present disclosure. The customer terminal 1 corresponds to “another information processing device” and a “second information processing device” according to the present disclosure. The store terminal 2 corresponds to an “information processing device” and a “first information processing device” according to the present disclosure. The image data corresponds to “electronic information” according to the present disclosure.

The store ST according to the present embodiment provides a service of generating printed matter and providing the generated printed matter to the customer P. Therefore, in the store ST according to the present embodiment, a printing device 3 that generates printed matter to be provided to the customer P is installed.

The printing system 1000 includes the customer terminal 1. The customer terminal 1 is, for example, a personal computer (PC) such as a smartphone or a tablet terminal. The customer terminal 1 communicates with a server device 4 via a network NW including a public line network, a dedicated line, and other communication circuits.

The printing system 1000 includes the store terminal 2. The store terminal 2 is, for example, a PC such as a tablet terminal. The store terminal 2 is installed at a predetermined position of the store ST. The number of store terminals 2 installed in the store ST is not limited to one as shown in FIG. 1, and may be plural. The store terminal 2 communicates with the server device 4 via the network NW. The store terminal 2 also communicates with the printing device 3 installed in the store ST. The store terminal 2 transmits the image data to the printing device 3 to cause the printing device 3 to generate printed matter on which an image indicated by the image data is printed.

A printing method of the printing device 3 may be an ink jet method, an electronic transfer method, or the like. As a print medium of the printing device 3, for example, paper, a film, a cloth, or the like can be adopted. The printing device 3 may be a multi-function machine having functions other than printing functions such as a scanning function.

The printing system 1000 includes the server device 4.

The server device 4 is a device that processes information using the customer terminal 1 and the store terminal 2 as clients. The server device 4 is connected to the network NW and communicates with the customer terminal 1 and the store terminal 2. In each drawing, the server device 4 is represented by one block, but this does not necessarily mean that the server device 4 is composed of a single device. For example, the server device 4 may include a plurality of server devices having different processing contents.

2. Configurations of Units of Printing System

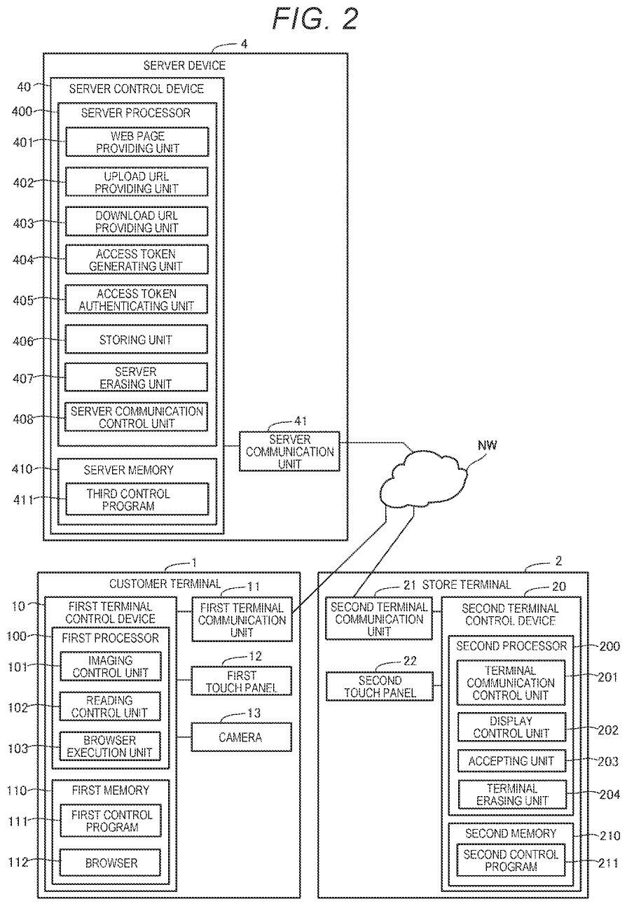

FIG. 2 is a diagram showing configurations of the customer terminal 1, the store terminal 2, and the server device 4.

First, the configuration of the customer terminal 1 will be described.

As shown in FIG. 2, the customer terminal 1 includes a first terminal control device 10, a first terminal communication unit 11, a first touch panel 12, and a camera 13.

The first terminal control device 10 is a control device that controls the respective units of the customer terminal 1. The first terminal control device 10 includes a first processor 100 which is a processor such as a central processing unit (CPU), a first memory 110, and an interface circuit for connecting other devices and sensors. The first terminal control device 10 controls the respective units of the customer terminal 1.

The first memory 110 is a memory that stores programs and data. The first memory 110 stores a first control program 111, a browser 112, one or a plurality of pieces of image data, and data processed by the first processor 100. The first memory 110 has a nonvolatile storage area. The first memory 110 may have a volatile storage area and constitute a work area for the first processor 100. The first memory 110 includes, for example, a read only memory (ROM) or a random access memory (RAM).

The image data stored in the first memory 110 may be image data of a captured image taken by the camera 13, or may be image data downloaded from an external device capable of communicating with the customer terminal 1.

The first terminal communication unit 11 includes communication hardware such as a communication circuit, and communicates with the server device 4 connected to the network NW under the control of the first terminal control device 10. In the present embodiment, a wireless communication standard is illustrated as the communication standard of the first terminal communication unit 11, but the communication standard of the first terminal communication unit 11 may be a wired communication standard.

The first touch panel 12 includes a display panel such as a liquid crystal display panel, and a touch sensor provided over the display panel or integrally therewith. The display panel displays various types of information under the control of the first terminal control device 10. The touch sensor detects a touch operation and outputs the touch operation to the first terminal control device 10. The first terminal control device 10 executes processing corresponding to the touch operation based on an input from the touch sensor.

The camera 13 takes an image under the control of the first terminal control device 10. The camera 13 outputs image data of the captured image obtained by imaging, to the first terminal control device 10.

The first processor 100 functions as an imaging control unit 101 and a reading control unit 102 by reading and executing the first control program 111 stored in the first memory 110.

The imaging control unit 101 controls the camera 13 to cause the camera 13 to perform imaging. The imaging control unit 101 acquires image data of the captured image from the camera 13 and outputs the acquired image data of the captured image to the reading control unit 102.

When a two-dimensional code is included in the captured image indicated by the image data received from the imaging control unit 101, the reading control unit 102 reads information from a two-dimensional code CD included in the captured image. The information read from the two-dimensional code CD will be described later. The two-dimensional code CD is, for example, a QR code (registered trademark).

The two-dimensional code CD corresponds to a “code” according to the present disclosure.

The first processor 100 functions as a browser execution unit 103 by reading and executing the browser 112 stored in the first memory 110.

The browser execution unit 103 accesses a predetermined uniform resource locator (URL) of the server device 4 via the first terminal communication unit 11. The browser execution unit 103 executes various processing in response to access to the predetermined URL. The browser execution unit 103 displays a web page 1031 on the first touch panel 12.

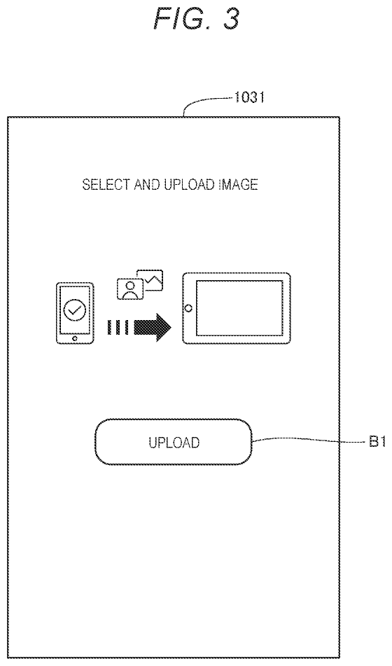

FIG. 3 is a diagram showing an example of the web page 1031.

The web page 1031 is a web page for uploading image data stored in the customer terminal 1 to the server device 4. The web page 1031 includes a button B1 for starting upload of the image data. When the button B1 is touch-operated on the web page 1031, the customer terminal 1 displays an image selection screen by a function of an operating system (OS). Then, the browser execution unit 103 uploads the image data of the image selected on the image selection screen to the server device 4.

Next, the configuration of the store terminal 2 will be described.

The store terminal 2 includes a second terminal control device 20, a second terminal communication unit 21, and a second touch panel 22.

The second terminal control device 20 is a control device that controls the respective units of the store terminal 2. The second terminal control device 20 includes a second processor 200 which is a processor such as a central processing unit (CPU), a second memory 210, and an interface circuit for connecting other devices and sensors. The second terminal control device 20 controls the respective units of the store terminal 2.

The second processor 200 corresponds to a “processor” according to the present disclosure.

The second memory 210 is a memory that stores programs and data. The second memory 210 stores a second control program 211 and data processed by the second processor 200. The second memory 210 has a nonvolatile storage area. The second memory 210 may have a volatile storage area, and constitute a work area for the second processor 200. The second memory 210 includes, for example, a ROM or a RAM.

The second control program 211 corresponds to a “program” according to the present disclosure.

The second terminal communication unit 21 includes communication hardware such as a communication circuit, and communicates with the server device 4 connected to the network NW under the control of the second terminal control device 20. The second terminal communication unit 21 communicates with the printing device 3 under the control of the second terminal control device 20. In the present embodiment, a wireless communication standard is illustrated as the communication standard of the second terminal communication unit 21, but the communication standard of the second terminal communication unit 21 may be a wired communication standard.

The second touch panel 22 includes a display panel such as a liquid crystal display panel, and a touch sensor provided over the display panel or integrally therewith. The display panel displays various types of information under the control of the second terminal control device 20. The touch sensor detects a touch operation and outputs the touch operation to the second terminal control device 20. The second terminal control device 20 executes processing corresponding to the touch operation based on an input from the touch sensor.

The second processor 200 functions as a terminal communication control unit 201, a display control unit 202, an accepting unit 203, and a terminal erasing unit 204 by reading and executing the second control program 211 stored in the second memory 210.

The terminal communication control unit 201 corresponds to a “receiving unit” according to the present disclosure.

The terminal communication control unit 201 communicates with the server device 4 via the second terminal communication unit 21. The terminal communication control unit 201 communicates with the printing device 3 via the second terminal communication unit 21.

The display control unit 202 displays various types of information on the second touch panel 22. In the present embodiment, the display control unit 202 displays a first store screen GM1 and a second store screen GM2 on the second touch panel 22.

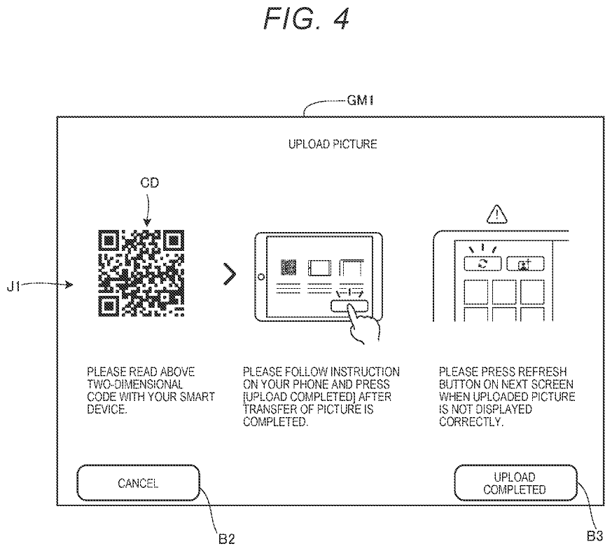

FIG. 4 is a diagram showing an example of the first store screen GM1.

The first store screen GM1 includes information J1 indicating a method of uploading the image data. The information J1 includes the two-dimensional code CD.

The first store screen GM1 includes a button B2 for stopping the display of the first store screen GM1.

The first store screen GM1 includes a button B3 for instructing completion of the upload of the image data. When the button B3 is touch-operated on the first store screen GM1, the display control unit 202 displays the second store screen GM2.

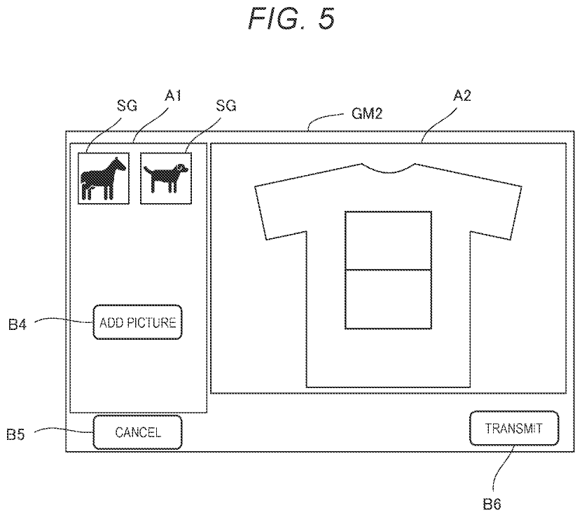

FIG. 5 is a diagram showing an example of the second store screen GM2.

The second store screen GM2 has a first area A1 and a second area A2. The first area A1 is an area for displaying a list of images SG indicated by the downloaded image data. The second area A2 is an area for processing the downloaded image SG.

The first area A1 includes a button B4 for downloading the image data uploaded to the server device 4. When the button B4 is touch-operated, the store terminal 2 downloads the image data uploaded to the server device 4.

The second store screen GM2 includes a button B5 for displaying the first store screen GM1.

The second store screen GM2 includes a button B6 for processing the downloaded image SG. The button B6 in the present embodiment is a button for causing the printing device 3 to print the image SG processed in the second area A2. When the button B6 is touch-operated, the store terminal 2 transmits print data to the printing device 3. The print data includes image data of the image SG displayed in the second area A2, and control commands conforming to a command language of the printing device 3.

Returning to the description of the functional units of the second processor 200, the accepting unit 203 accepts various operations from the customer P to the store terminal 2. The accepting unit 203 accepts a touch operation on each button of the first store screen GM1 and the second store screen GM2.

The terminal erasing unit 204 erases, from the second memory 210, the data received from the server device 4.

Next, the configuration of the server device 4 will be described.

The server device 4 includes a server control device 40 and a server communication unit 41.

The server control device 40 includes a server processor 400 which is a processor such as a CPU, a server memory 410, and an interface circuit for connecting other devices and sensors. The server control device 40 controls the respective units of the store terminal 2.

The server memory 410 is a memory that stores programs and data. The server memory 410 stores a third control program 411 and data processed by the server processor 400. The server memory 410 has a nonvolatile storage area. The server memory 410 may have a volatile storage area, and may constitute a work area for the server processor 400. The server memory 410 includes, for example, a ROM or a RAM.

The server communication unit 41 includes communication hardware such as a communication circuit, and communicates with the customer terminal 1 and the store terminal 2 connected to the network NW under the control of the server control device 40. The server communication unit 41 communicates with the printing device 3 under the control of the server control device 40. In the present embodiment, a wireless communication standard is illustrated as the communication standard of the server communication unit 41, but the communication standard of the server communication unit 41 may be a wired communication standard.

The server processor 400 functions as a web page providing unit 401, an upload URL providing unit 402, a download URL providing unit 403, an access token generating unit 404, an access token authenticating unit 405, a storing unit 406, a server erasing unit 407, and a server communication control unit 408 by reading and executing the third control program 411 stored in the server memory 410.

The web page providing unit 401 provides the web page 1031 to the customer terminal 1. The web page providing unit 401 provides the web page 1031 to the customer terminal 1 by causing the server communication control unit 408 to transmit display data of the web page 1031.

The upload URL providing unit 402 provides an upload URL. The upload URL is a URL for uploading the image data to the server device 4. The upload URL providing unit 402 provides the upload URL to the customer terminal 1 by causing the server communication control unit 408 to transmit the upload URL.

The download URL providing unit 403 provides a download URL. The download URL is a URL for downloading the image data from the server device 4. The download URL providing unit 403 provides the download URL to the store terminal 2 by causing the server communication control unit 408 to transmit the download URL.

The access token generating unit 404 generates a first access token. The first access token is a character string indicating access authority to a first URL that is a URL of a first application programming interface (API). The first API is an interface used in functioning of a program for providing the upload URL.

The access token generating unit 404 generates a second access token. The second access token is a character string indicating access authority to a second URL that is a URL of a second API and a third URL that is a URL of a third API. The second API is an interface used in functioning of a program for providing the download URL. The third API is an interface used in functioning of a program for erasing data stored in the server memory 410. In the following description, when the first access token and the second access token are not distinguished from each other, they are expressed as an “access token”.

The access token generating unit 404 sets an expiration date of the generated access token and generates expiration date information indicating the set expiration date.

The access token authenticating unit 405 authenticates the access token.

The storing unit 406 stores various pieces of data in the server memory 410.

The server erasing unit 407 erases the stored data from the server memory 410.

The server communication control unit 408 communicates with the customer terminal 1 and the store terminal 2 via the server communication unit 41.

3. Operation of Printing System

Next, an operation of the printing system 1000 will be described.

3-1. Operation Related to Display of First Store Screen

First, an operation of the printing system 1000 related to display of the first store screen GM1 will be described.

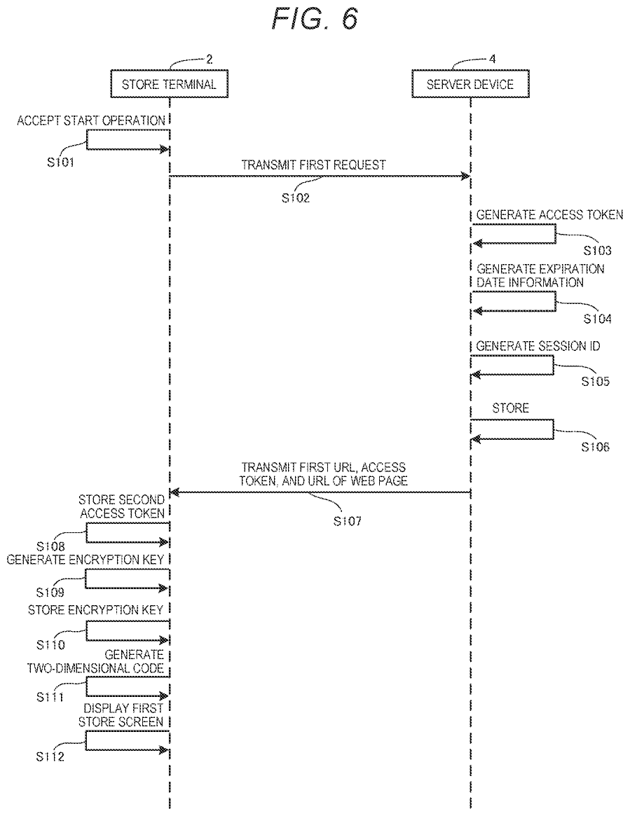

FIG. 6 is a sequence diagram showing the operation of the printing system 1000.

The accepting unit 203 of the store terminal 2 accepts a start operation to start upload of the image data from the customer P (step S101).

Next, the terminal communication control unit 201 transmits a first request to the server device 4 (step S102). The first request is information for requesting data related to the start of upload of the image data.

When the server communication control unit 408 of the server device 4 receives the first request, the access token generating unit 404 generates an access token (step S103).

Next, the access token generating unit 404 generates expiration date information indicating the expiration date of the generated access token as necessary (step S104).

Next, the storing unit 406 generates a session identification (ID) (step S105). The session ID is information for identifying a session related to upload of the image data.

Next, the storing unit 406 stores, in the server memory 410, the first access token and the second access token generated in step S103, the expiration date information generated in step S104, and the session ID generated in step S105 in association with each other (step S106).

Next, in response to the first request, the server communication control unit 408 transmits, to the store terminal 2, the first URL, the first access token and the second access token generated in step SB2, and the URL of the Web page 1031 (step S107).

Upon receiving the response to the first request, the terminal communication control unit 201 of the store terminal 2 stores the received second access token in the second memory 210 (step S108). The first URL, the first access token, and the URL of the web page 1031 are temporarily stored in the second memory 210 until the two-dimensional code CD is generated.

Next, the display control unit 202 generates an encryption key for encrypting the image data (step S109).

Next, the display control unit 202 stores the generated encryption key in the second memory 210 (step S110).

Next, the display control unit 202 generates the two-dimensional code CD (step S111). In the two-dimensional code CD generated in step S111, the first URL received as a response to the first request, the first access token received as a response to the first request, the URL of the web page 1031 received as a response to the first request, and the encryption key generated in step S109 are recorded. The first URL, the first access token, the URL of the web page 1031, and the encryption key may be recorded in the two-dimensional code CD as one character string.

Next, the display control unit 202 displays the first store screen GM1 including the two-dimensional code CD generated in step S111 (step S112).

3-2. Operation Related to Upload of Image Data

Next, an operation of the printing system 1000 related to the upload of the image data will be described.

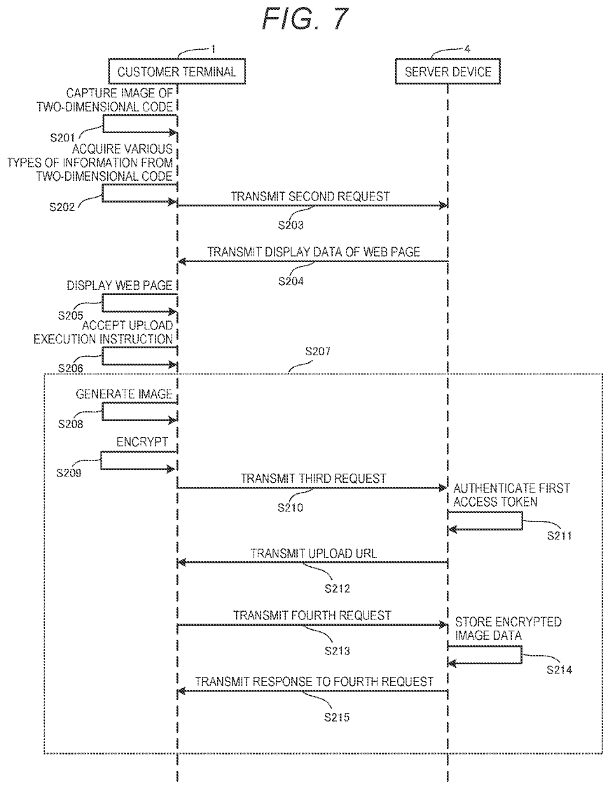

FIG. 7 is a sequence diagram showing the operation of the printing system 1000. At the start of the operation in FIG. 7, the store terminal 2 displays the first store screen GM1.

The imaging control unit 101 of the customer terminal 1 captures an image of the two-dimensional code CD displayed by the first store screen GM1 with the camera 13 (step S201).

Next, the reading control unit 102 acquires various types of information from the two-dimensional code CD shown in the captured image (step S202).

Next, the browser execution unit 103 transmits a second request based on the URL of the web page 1031 acquired from the two-dimensional code CD (step S203). The second request is information for requesting the web page 1031.

When the server communication control unit 408 of the server device 4 receives the second request, the web page providing unit 401 causes the server communication control unit 408 to transmit display data of the web page 1031 as a response to the second request (step S204).

When the browser execution unit 103 receives the display data of the web page 1031, the browser execution unit 103 displays the web page 1031 indicated by the received display data (step S205).

After the web page 1031 is displayed, when an image to be uploaded is selected on the image selection screen, the browser execution unit 103 accepts an upload execution instruction from the OS of the customer terminal 1 (step S206).

Next, the customer terminal 1 and the server device 4 perform a first loop processing (step S207). The first loop processing is performed for each image selected on the image selection screen. The first loop processing includes step S208 to step S215.

The browser execution unit 103 of the customer terminal 1 generates the image SG of the selected image, and displays the generated image SG on the web page 1031 (step S208). A file name may be displayed without generating the image SG.

Next, the browser execution unit 103 encrypts the image data of the image SG generated in step S208 with the encryption key acquired in step S202 (step S209). Hereinafter, the image data of the encrypted image SG is referred to as “encrypted image data”.

The encrypted image data corresponds to “encrypted electronic information” according to the present disclosure.

Next, the browser execution unit 103 transmits a third request to the server device 4 based on the first URL acquired in step S202 (step S210). The third request is information for requesting the upload URL, and includes the first access token acquired in step S202.

When the server communication control unit 408 of the server device 4 receives the third request, the access token authenticating unit 405 authenticates the first access token included in the third request (step S211). The authentication in step S211 determines whether the first access token that is the same as the first access token included in the third request is stored in the server memory 410. When it is determined that the first access token that is the same as the first access token included in the third request is stored in the server memory 410, the access token authenticating unit 405 determines that the authentication of the first access token is successful. On the other hand, when it is determined that the first access token that is the same as the first access token included in the third request is not stored in the server memory 410, the access token authenticating unit 405 determines that the authentication of the first access token fails.

When the access token authenticating unit 405 determines in step S211 that the authentication of the first access token is successful, the upload URL providing unit 402 causes the server communication control unit 408 to transmit the upload URL as a response to the third request (step S212).

When the browser execution unit 103 of the customer terminal 1 receives the upload URL, the browser execution unit 103 transmits a fourth request to the server device 4 (step S213). The fourth request is information for requesting upload of the encrypted image data to the upload URL. The fourth request includes the upload URL transmitted in step S212 and the encrypted image data encrypted in step S209.

When the server communication control unit 408 of the server device 4 receives the fourth request, the storing unit 406 stores the encrypted image data included in the fourth request in the upload URL included in the fourth request (step S214).

Next, the server communication control unit 408 transmits a response to the fourth request to the customer terminal 1 (step S215).

After executing the first loop processing for all the images selected in the display of the web page 1031, the printing system 1000 exits the first loop processing.

3-3. Operation Related to Download of Image Data

Next, an operation of the printing system 1000 related to download of the image data will be described.

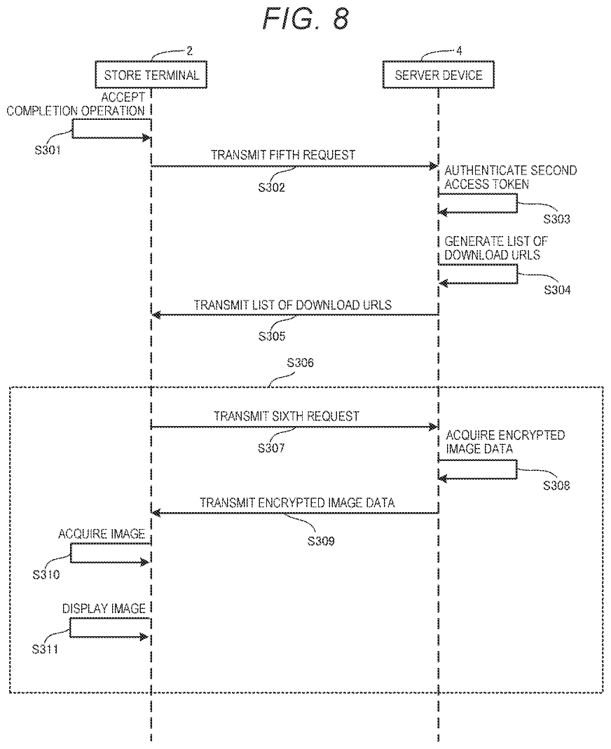

FIG. 8 is a sequence diagram showing the operation of the printing system 1000.

The accepting unit 203 of the store terminal 2 accepts a completion operation indicating that the upload is completed from the customer P via the button B3 (step S301).

The terminal communication control unit 201 transmits a fifth request to the server device 4 based on the second URL stored in the second memory 210 (step S302). The fifth request is information for requesting the download URL, and includes the second access token stored in the second memory 210.

When the server communication control unit 408 of the server device 4 receives the fifth request, the access token authenticating unit 405 authenticates the second access token included in the fifth request (step S303). The authentication in step S303 determines whether the second access token that is the same as the second access token included in the fifth request is stored in the server memory 410. When it is determined that the second access token that is the same as the second access token included in the fifth request is stored in the server memory 410, the access token authenticating unit 405 determines that the authentication of the second access token is successful. On the other hand, when it is determined that the second access token that is the same as the second access token included in the fifth request is not stored in the server memory 410, the access token authenticating unit 405 determines that the authentication of the second access token fails.

When the access token authenticating unit 405 determines in step S303 that the authentication of the second access token is successful, the download URL providing unit 403 generates a list of download URLs (step S304). In step S304, the download URL providing unit 403 generates a download URL for each encrypted image data stored in the server memory 410.

Next, the download URL providing unit 403 causes the server communication control unit 408 to transmit the list of download URLs as a response to the fifth request (step S305).

Next, when the terminal communication control unit 201 of the store terminal 2 receives the list of download URLs, the store terminal 2 and the server device 4 perform a second loop processing (step S306). The second loop processing is performed for each download URL included in the list of download URLs received as a response to the fifth request. The second loop processing includes step S307 to step S311.

The terminal communication control unit 201 transmits a sixth request to the server device 4 (step S307). The sixth request is information for requesting download of the encrypted image data from the download URL. The download URL is recorded in the sixth request.

Upon receiving the sixth request, the server communication control unit 408 of the server device 4 acquires the encrypted image data from the download URL recorded in the received sixth request (step S308).

Next, the server communication control unit 408 transmits the encrypted image data acquired in step S308 to the store terminal 2 as a response to the sixth request (step S309).

When the terminal communication control unit 201 of the store terminal 2 receives the encrypted image data from the server device 4, the display control unit 202 decrypts the received encrypted image data with the encryption key stored in the second memory 210 to acquire the image SG (step S310).

Next, the display control unit 202 displays the image SG acquired in step S310 in the first area A1 of the second store screen GM2 (step S311). The acquisition and display of the image SG may not be implemented.

After executing the second loop processing for all the download URLs included in the list of download URLs, the printing system 1000 exits the second loop processing.

3-4. Operation Related to Erasing of Image Data

Next, an operation of the printing system 1000 related to erasing of the image data will be described.

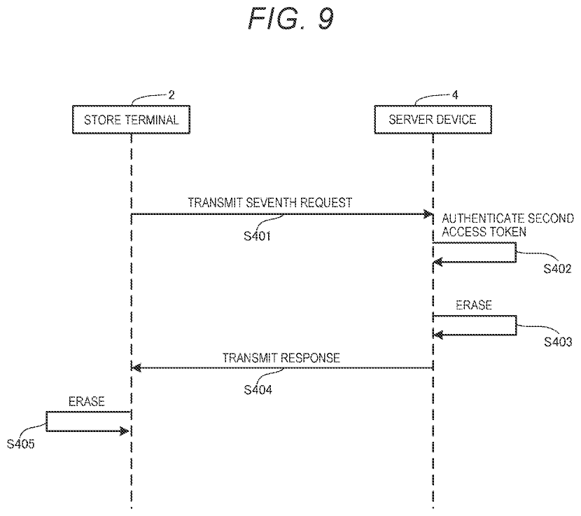

FIG. 9 is a sequence diagram showing the operation of the printing system 1000. The operation shown in FIG. 9 is started when the store terminal 2 transmits print data to the printing device 3, for example.

The terminal communication control unit 201 of the store terminal 2 transmits a seventh request based on the third URL stored in the second memory 210 (step S401). The seventh request is information for requesting erasing of data, and includes the second access token.

When the server communication control unit 408 of the server device 4 receives the seventh request, the access token authenticating unit 405 authenticates the second access token included in the seventh request (step S402). The authentication in step S402 is performed in the same manner as the authentication in step S303.

When the access token authenticating unit 405 determines that the authentication of the second access token is successful, the server erasing unit 407 erases the data stored in step S106 and the encrypted image data stored in step S214 (step S403).

Next, the server communication control unit 408 transmits a response to the seventh request to the store terminal 2 (step S404).

Next, when the terminal communication control unit 201 of the store terminal 2 receives the response to the seventh request, the terminal erasing unit 204 erases, from the second memory 210, the image data of the image SG, the encryption key, the second URL, and the second access token.

4. Other Embodiments

The embodiment described above shows one aspect, and any modifications and applications can be made.

In the embodiment described above, the server device 4 is configured to transmit the first URL and the URL of the web page 1031 to the store terminal 2 in response to the first request, but the store terminal 2 may hold these two types of URLs in advance.

In the embodiment described above, the image data is illustrated as the “electronic information” according to the present disclosure. However, the “electronic information” according to the present disclosure is not limited to the image data, and may be other information such as a document file.

In the embodiment described above, the PC such as a tablet terminal is illustrated as the “information processing device” and the “first information processing device” according to the present disclosure. However, the “information processing device” and the “first information processing device” according to the present disclosure may be a printing device including a display and an operation panel capable of operating a screen displayed on the display.

In the embodiment described above, the case where one customer P transmits the image data to the store terminal 2 is illustrated. In another embodiment, a plurality of customers P may share the two-dimensional code CD displayed on the store terminal 2, and a plurality of customer terminals 1 may transmit the image data to the store terminal 2.

In the embodiment described above, the two-dimensional code CD is illustrated as the “code” according to the present disclosure, but the “code” according to the present disclosure may be a one-dimensional code such as a bar code.

In the embodiment described above, the store terminal 2 and the printing device 3 directly communicate with each other. In the other embodiment, the store terminal 2 may communicate with a control device that controls the printing device 3.

The functions of the first processor 100, the second processor 200, and the server processor 400 may be implemented by a plurality of processors or a semiconductor chip.

Each unit shown in FIG. 2 is an example, and is not particularly limited. It is not always necessary to mount hardware corresponding to each unit individually, and it is of course possible to adopt a configuration in which one processor executes a program to implement the function of each unit. A part of the functions implemented by software may be implemented by hardware, or a part of the functions implemented by hardware may be implemented by software. In addition, specific detailed configurations of the customer terminal 1, the store terminal 2, and the server device 4 can be freely changed.

Step units of the operations shown in FIGS. 6, 7, 8, and 9 are divided according to the main processing contents in order to facilitate understanding of the operations of the respective units of the printing system 1000, and the present disclosure is not limited by a way of dividing processing units and names of the processing units. Processing may be divided into more step units according to the processing contents. One step unit may be divided so as to include more processing. An order of the steps may be appropriately changed.

5. Summary of Present Disclosure

Hereinafter, a summary of the present disclosure will be added.

(Appendix 1) An electronic information processing system including: a first information processing device; and a second information processing device configured to store electronic information, in which the first information processing device is configured to display a code in which a URL of a web page is recorded, the second information processing device is configured to read the code displayed by the first information processing device, access the URL acquired from the read code to display the web page, and transmit the electronic information to a server device via the displayed web page, and the first information processing device is configured to receive the electronic information from the server device.

According to this configuration, the electronic information stored in the second information processing device can be transmitted to the first information processing device by the web page displayed by reading the code. Therefore, electronic information can be transmitted to another information processing device without installing a dedicated application, registering an email address, or the like, so that the procedure for transmitting the electronic information to the other information processing devices can be simplified.

(Appendix 2) The electronic information processing system according to appendix 1, in which a first URL of a first API that acquires an upload URL for uploading the electronic information to the server device and a first access token that is an access authority to the first URL are further recorded in the code, and the second information processing device is configured to acquire the upload URL using the first URL and the first access token acquired from the read code, and transmit the electronic information to the server device using the acquired upload URL.

According to this configuration, the electronic information is uploaded using the first access token, so that security related to the upload of the electronic information can be ensured without performing user authentication such as password input. Accordingly, the procedure for transmitting the electronic information to the other information processing device can be further simplified, and security related to the upload of the electronic information to the server device can be ensured.

(Appendix 3) The electronic information processing system according to appendix 1 or 2, in which the first information processing device is configured to acquire a download URL for downloading the electronic information from the server device using a second URL of a second API that acquires the download URL and a second access token that is an access authority to the second URL, and receive the electronic information from the server device using the acquired download URL.

According to this configuration, the electronic information is downloaded using the second access token, so that security related to the download of the electronic information can be ensured without performing user authentication such as password input. Accordingly, the procedure for transmitting the electronic information to the other information processing device can be further simplified, and security related to the download of the electronic information from the server device can be ensured.

(Appendix 4) The electronic information processing system according to any one of appendixes 1 to 3, in which the first information processing device is configured to generate an encryption key that encrypts the electronic information, and display the code in which the generated encryption key is recorded, the second information processing device is configured to encrypt the electronic information with the encryption key acquired from the read code, and transmit encrypted electronic information, which is the encrypted electronic information, to the server device, and the first information processing device is configured to receive the encrypted electronic information from the server device, and decrypt the received encrypted electronic information with the generated encryption key.

According to this configuration, the electronic information stored in the server device can be encrypted, and the first information processing device can decrypt the electronic information without the server device storing the encryption key. Accordingly, the other information processing device can appropriately acquire the electronic information while preventing the leakage of the electronic information from the server device.

(Appendix 5) The electronic information processing system according to any one of appendixes 1 to 4, in which after the received electronic information is processed in the first information processing device, the received electronic information is erased from the first information processing device.

According to this configuration, the electronic information can be erased from the first information processing device after the processing of the electronic information, so that a risk that the electronic information leaks from the other information processing device after the processing of the electronic information can be reduced.

(Appendix 6) The electronic information processing system according to appendix 5, in which the first information processing device is configured to, as the processing of the electronic information, transmit the received electronic information to a printing device, or transmit the received electronic information to a control device that controls the printing device.

According to this configuration, the electronic information processing system can be constructed as a printing system.

(Appendix 7) The electronic information processing system according to appendix 5, in which the first information processing device is a printing device and is configured to print the received electronic information as the processing of the electronic information.

According to this configuration, the effects same as those of the electronic information processing system according to appendix 6 are achieved.

(Appendix 8) An electronic information processing method including: a first information processing device displaying a code in which a URL of a web page is recorded; a second information processing device configured to store electronic information reading the code displayed by the first information processing device, accessing the URL obtained by reading the code to display the web page, and transmitting the electronic information to a server device by the displayed web page; and the first information processing device receiving the electronic information from the server device.

According to this configuration, the effects same as those of the electronic information processing system according to the appendix 1 are achieved.

(Appendix 9) A program causing a processor of an information processing device to function as: a display control unit configured to display a code in which a URL of a web page is recorded; and a receiving unit configured to receive, from another information processing device different from the information processing device, electronic information stored in the other information processing device via a server device by the web page displayed by the other information processing device after the code is read.

According to this configuration, the effects same as those of the electronic information processing system according to appendix 1 are achieved.

What is claimed is:

1. An electronic information processing system comprising:
a first information processing device; and
a second information processing device configured to store electronic information, wherein
the first information processing device is configured to display a code in which a URL of a web page is recorded,
the second information processing device is configured to read the code displayed by the first information processing device, access the URL obtained from the read code to display the web page, and transmit the electronic information to a server device via the displayed web page, and
the first information processing device is configured to receive the electronic information from the server device.

2. The electronic information processing system according to claim 1, wherein
a first URL of a first API that acquires an upload URL for uploading the electronic information to the server device and a first access token that is an access authority to the first URL are further recorded in the code, and
the second information processing device is configured to acquire the upload URL using the first URL and the first access token acquired from the read code, and transmit the electronic information to the server device using the acquired upload URL.

3. The electronic information processing system according to claim 1, wherein
the first information processing device is configured to acquire a download URL for downloading the electronic information from the server device using a second URL of a second API that acquires the download URL and a second access token that is an access authority to the second URL, and receive the electronic information from the server device using the acquired download URL.

4. The electronic information processing system according to claim 1, wherein
the first information processing device is configured to generate an encryption key that encrypts the electronic information, and display the code in which the generated encryption key is further recorded,
the second information processing device is configured to encrypt the electronic information with the encryption key acquired from the read code, and transmit encrypted electronic information, which is the encrypted electronic information, to the server device, and
the first information processing device is configured to receive the encrypted electronic information from the server device, and decrypt the received encrypted electronic information with the generated encryption key.

5. The electronic information processing system according to claim 1, wherein
after the received electronic information is processed in the first information processing device, the received electronic information is erased from the first information processing device.

6. The electronic information processing system according to claim 5, wherein
the first information processing device is configured to, as the processing of the electronic information, transmit the received electronic information to a printing device, or transmit the received electronic information to a control device that controls the printing device.

7. The electronic information processing system according to claim 5, wherein
the first information processing device is a printing device and is configured to print the received electronic information as the processing of the electronic information.

8. An electronic information processing method comprising:
a first information processing device displaying a code in which a URL of a web page is recorded;
a second information processing device configured to store electronic information reading the code displayed by the first information processing device, accessing the URL obtained by reading the code to display the web page, and transmitting the electronic information to a server device via the displayed web page; and
the first information processing device receiving the electronic information from the server device.

9. A program comprising:
causing a processor of an information processing device to function as a display control unit configured to display a code in which a URL of a web page is recorded, and
a receiving unit configured to receive, from a server device, electronic information stored in another information processing device different from the information processing device after the code is read, the electronic information being transmitted to the server device via the web page displayed by the other information processing device.
